(19) United States
(12) Patent Application Publication
(10) Pub. No.: US 2026/0084153 A1
(43) Pub. Date: Mar. 26, 2026

(54) MAGNETIC-BASED PORTABLE MULTI-CELL SEPARATION DEVICE

(71) Applicant: Daegu Gyeongbuk Institute of Science and Technology, Dalseong-gun (KR)

(72) Inventors: CheolGi KIM, Daegu (KR); Byeongwha LIM, Daegu (KR); Yumin KANG, Daegu (KR); Jonghwan YOON, Seoul (KR); Abbas ALI, Daegu (KR)

(73) Assignee: Daegu Gyeongbuk Institute of Science and Technology, Dalseong-gun (KR)

(21) Appl. No.: 19/251,042

(22) Filed: Jun. 26, 2025

(30) Foreign Application Priority Data
Sep. 23, 2024 (KR) 10-2024-0128162

(51) Int. Cl. B01L 3/00; B03C 1/02

(52) U.S. Cl. CPC B01L 3/502753; B03C 1/02; B01L 2300/0816; B03C 2201/26

(57) ABSTRACT

The present invention discloses a magnetically driven portable multi-cell separation device. According to one embodiment of the present invention, the magnetically driven portable multi-cell separation device includes: A microscope capable of nano-scale observation, A chip unit, positioned below the microscope, enabling selective cell sorting and capture, A magnetic field generator, which is adjacent to the chip unit and can control the magnetic field via a magnetic member, and A control unit, which controls the operation of the imaging unit, the chip unit, and the magnetic field generator.

### CROSS-REFERENCE TO RELATED APPLICATION

This application claims priority from and the benefit of Korean Patent Application No. 10-2024-0128162 filed on Sep. 23, 2024, in the Korean Intellectual Property Office, the disclosure of which is incorporated herein by reference.

### BACKGROUND OF THE DISCLOSURE

### Field of the Disclosure

Example embodiments relate to a magnetic-based portable multi-cell separation device, and more particularly, to a magnetic-based portable multi-cell separation device that utilizes micro-magnets to operate in a simplified system under low magnetic field and low-frequency conditions.

### Description of the Related Art

The paradigm of modern medicine is shifting from diagnosis for treatment to a diagnostic priority for prevention and prognosis, thereby increasing the importance of point-of-care testing (POCT). In particular, cell diagnostics have emerged as a new field, as they can provide insights into the pathogenesis and prognosis of various diseases. As miniaturized and portable analytical systems continue to gain importance in POCT, researchers are exploring the integration of lab-on-a-chip (LOC) systems to simplify peripheral devices for cell-level diagnostics.

By combining POCT and LOC technologies, portable devices have the potential to facilitate the selective detection of biologically active substances, analyze drug responsiveness, and monitor cell behavior in real time at the single-cell level. Cell-on-a-chip technology is being developed to be user-friendly and accessible even to individuals without technical expertise. Researchers have implemented portable cell analysis devices with high sensitivity and rapid analysis speeds by exploring various techniques in cell diagnostics, including enzyme-linked immunosorbent assays (ELISA) incorporating antigen-antibody binding technology, filtration technologies utilizing microfilters and micropores in microfluidic structures, and electrophoresis, genoelectrophoresis, acoustophoresis, and magnetophoresis.

However, despite these advancements, the ability to effectively manipulate individual cells remains limited and presents an ongoing challenge for portable cell analysis.

Korean Registered Patent Publication No. 1015766240000 discloses a device for the transport, trapping, and release of biomaterials using a micro-magnetophoretic channel circuit and a magnetic structure.

FIG. 1 is a diagram illustrating a conventional micro-magnetophoretic channel circuit.

The prior art shown in FIG. 1 essentially utilizes a magnetic force generation device that includes a two-axis electromagnet system and a semi-circular magnetic microstructure, which transports biomaterials by applying an in-plane magnetic field.

However, in order to control the device for classifying, trapping, and releasing biomaterials, it is necessary to modify the existing magnetic field direction, requiring the additional use of a vertical magnetic field application device or a current application device.

As a result, there are limitations in miniaturizing the entire system and utilizing it as a highly portable cell-on-a-chip platform.

### SUMMARY

One embodiment of the present invention aims to provide a magnetic-based portable multi-cell separation device that utilizes micro-magnets to operate in a simplified system under low magnetic field and low-frequency conditions, thereby overcoming the problems of the prior art.

According to an example embodiment, a magnetic-based portable multi-cell separation device comprises: a microscope configured to perform observation, a chip unit disposed below the microscope and configured to enable selective cell sorting and collection, a magnetic field generation unit configured to adjust a magnetic field, wherein the chip unit is disposed within an internal space of a magnetic member having magnetic properties, and a control unit configured to control an operation of the microscope.

The chip unit comprises: a first chip unit configured to move and sort a plurality of cells, a second chip unit spaced apart from the first chip unit and configured to sort target cells separated from the first chip unit, and a third chip unit configured to sort cells other than the target cells separated from the first chip unit.

The first chip unit comprises: a plurality of circular magnets having magnetic properties and continuously arranged to perform transport, a capture magnet disposed adjacent to the plurality of circular magnets and configured to perform capture, and a sorting magnet disposed at one end of the plurality of circular magnets and configured to perform sorting.

The plurality of circular magnets are arranged in series, in parallel, or in a combination of series and parallel.

The sorting magnet has a plurality of notches formed in a circumferential direction toward the center.

The circular magnets, the capture magnet, and the sorting magnet are made of a material comprising nickel-iron (NiFe).

A first chamber for storing target cells is provided at an end of the second chip unit.

A second chamber for storing cells other than the target cells is provided at an end of the third chip unit.

The device further comprises a base plate configured to enable the magnetic field generation unit to rotate horizontally.

An outer circumference of the base plate is formed with a toothed structure.

The device further comprises a driving unit configured to enable the magnetic field generation unit to rotate horizontally.

The control unit comprises a microcontroller configured to perform computational processing of data.

The cell sorting and collection are controlled by either a labeled or label-free method.

The magnetic-based portable multi-cell separation device according to the present invention has the following advantages:

First, by altering the structure of micro-magnets, local magnetic energy variations can be induced, which can replace the effect of the vertical magnetic field application device or current application device that was additionally used in the prior art for operating trapping and release devices.

Second, since the jump motion of magnetic particles can be controlled under operating conditions of a low magnetic field (50 Oe) and low frequency (1 Hz or less), a simplified system utilizing permanent magnets instead of an electromagnet system enables precise control of biomaterials.

Third, by simplifying the system, high portability is achieved, making it applicable as an essential cell manipulation technology for next-generation biopharmaceutical applications, such as point-of-care testing (POCT) kits.

### BRIEF DESCRIPTION OF THE FIGURES

Embodiments will be described in more detail with regard to the figures, wherein like reference numerals refer to like parts throughout the various figures unless otherwise specified, and wherein:

FIG. 1 is a diagram illustrating a conventional micro-magnetophoretic channel circuit.

FIG. 2 is a schematic diagram illustrating a magnetic-based portable multi-cell separation device according to one embodiment of the present invention.

FIG. 3 is a schematic diagram illustrating a simplified magnetic field generation unit of a magnetic-based portable multi-cell separation device according to one embodiment of the present invention.

FIG. 4 is another schematic diagram illustrating a simplified magnetic field generation unit of a magnetic-based portable multi-cell separation device according to one embodiment of the present invention.

FIG. 5 is a schematic diagram illustrating an example in which a magnetic-based portable multi-cell separation device enables selective cell sorting and collection using nano-micro scale notched micro-magnets according to one embodiment of the present invention.

FIG. 6 is a schematic diagram illustrating an engineering approach of UV optical and thermal scanning probe lithography for micro-magnets and nano-scale notches in a magnetic-based portable multi-cell separation device according to one embodiment of the present invention.

FIG. 7 is a schematic diagram illustrating an SEM image of notched micro-magnets in a magnetic-based portable multi-cell separation device according to one embodiment of the present invention.

FIGS. 8A to 8E are diagrams illustrating the relationship between the magnetic domain of notched disk micro-magnets and the magnetic carrier dynamics.

FIG. 8A is a diagram showing the observed magnetic domain and corresponding simulation when an in-plane magnetic field of 50 Oe is applied to quadruple-notched disk micro-magnets with different depths (D).

FIG. 8B is a diagram illustrating the change in energy barrier width (arc) (Xp) according to notch depth in a disk micro-magnet magnetized in the notch direction.

FIG. 8C is a diagram comparing the simulated magnetic domains and energy landscape (purple arrows) according to notch depth when the in-plane magnetic field angle changes from 135° to 0° at 40 Oe.

FIG. 8D is a diagram comparing the jumping carrier positions between a disk micro-magnet (magnetic disk, blue) and a notched disk micro-magnet (notch-patterned magnetic disk, red) over 20 magnetic field rotation cycles. The jumping position corresponds to the angle at which the carrier completely detaches from the micro-magnet (indicated by white arrows in ii). The distribution of red dots indicates confinement near the notches.

FIG. 8E is a diagram showing the phase delay of magnetic carriers and changes in jump distance over 20 repetitions of external magnetic field rotation, with different colors representing variations according to notch depth.

FIGS. 9A to 9C are diagrams illustrating the regulation of magnetic carrier motion facilitated by notched disk micro-magnets.

FIG. 9A shows the frequency variation of micro-magnets with a notch width of 3 μm and a depth of 3 μm as the magnetic field frequency increases, using a 2.0 μm magnetic carrier. The magnetic field strength is 40 Oe, and the micro-magnet has a diameter of 20 μm.

FIG. 9B illustrates the variation in the critical frequency of the magnetic carrier as a function of notch depth under the same conditions, with an abnormal phase separation observed between 30 and 60 Oe in the case of notched disks.

FIG. 9C compares the measured displacement of magnetic carriers smaller than the notch width under different magnetic field strengths with the magnetic domain shape and magnetic energy distribution around the notch. The scale bar represents 5 μm, while the notch width is 3 μm and the depth is 5 μm.

FIGS. 10A to 10C illustrate the separation conditions for magnetic carriers of different sizes in notched disk micro-magnets.

FIG. 10A shows the jump distribution of magnetic carriers according to their size in a notched disk micro-magnet with a notch depth of 5 μm under Type 2-2 conditions.

FIG. 10B illustrates the jump probability distribution of a 2.8 μm magnetic carrier as a function of notch depth under Type 2-2 conditions.

FIG. 10C is a phase diagram representing the motion of magnetic carriers influenced by notch width (3 μm, 5 μm, and 7 μm) and magnetic field strength. In the diagram, the carrier jump for Type 2-2 corresponds to operating parameters where the speed is 0.2 Hz or lower and the jump distance exceeds 7.5 μm (colored regions).

FIGS. 11A to 11C illustrate the autonomous separation of carriers and the simultaneous separation of THP-1 and MCF-7 cells using a POCT system with a Halbach magnet assembly.

FIG. 11A shows the separation of three different sizes of magnetic carriers (2.8, 4.5, and 6.0 μm) into individual compartments using two types of notched disk micro-magnet devices. The upper notch has a depth of 5 μm and a width of 3 μm, while the lower notch has a depth of 7 μm and a width of 6 μm.

FIG. 11B illustrates the simultaneous separation of THP-1 and MCF-7 cells. The separation of live THP-1 and MCF-7 cells was tested in a cell culture environment (10% FBS RPMI medium) using a multi-notched disk micro-magnet device. The trajectories of live THP-1 and MCF-7 cells were observed in the multi-notched disk micro-magnet device (i-iv), showing that they were separated into individual compartments under a rotating magnetic field of 40 Oe at 0.2 Hz.

FIG. 11C presents bright-field and fluorescence images of captured THP-1 cells stained with a green fluorescent dye and labeled MCF-7 cells in separate compartments.

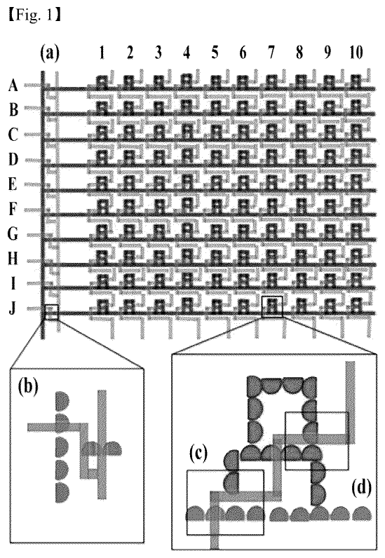

### DETAILED DESCRIPTION OF THE DISCLOSURE

Hereinafter, a detailed description of the compound diffractive multifocal intraocular lens according to a preferred embodiment will be provided with reference to the accompanying drawings. In this description, the same reference numerals are used for the same components, and repetitive descriptions as well as detailed explanations of known functions and configurations that may obscure the gist of the invention are omitted. The embodiments of the invention are provided to more fully explain the present invention to those of ordinary skill in the art. Therefore, the shapes and sizes of elements in the drawings may be exaggerated for clarity.

The specific structural or functional descriptions of embodiments according to the concept of the present invention disclosed in this specification are merely illustrative for the purpose of explaining the embodiments according to the concept of the present invention. The embodiments according to the concept of the present invention may be implemented in various forms and are not limited to the embodiments described in this specification.

Since the embodiments according to the concept of the present invention may undergo various modifications and have different forms, they are illustrated in the drawings and described in detail in this specification. However, this is not intended to limit the embodiments according to the concept of the present invention to specific disclosed forms, but rather includes modifications, equivalents, or substitutes that fall within the spirit and scope of the present invention.

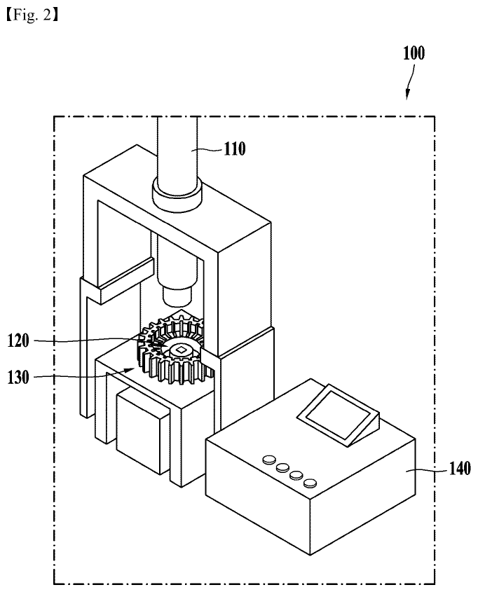

FIG. 2 is a schematic diagram illustrating a magnetic-based portable multi-cell separation device according to one embodiment of the present invention.

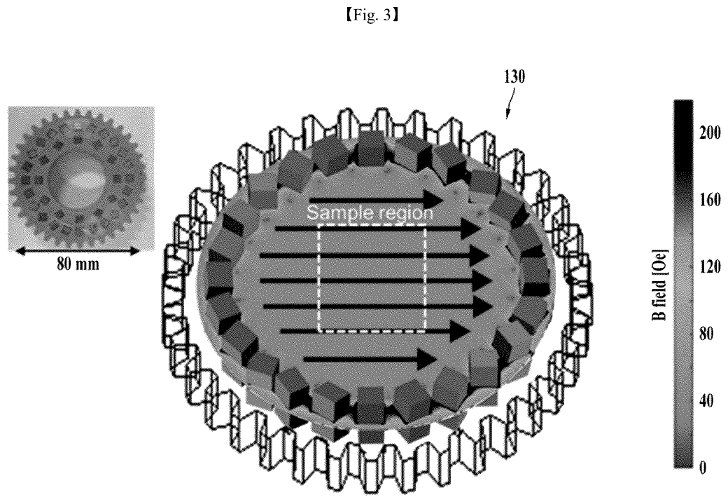

FIG. 3 is a schematic diagram illustrating a simplified magnetic field generation unit of a magnetic-based portable multi-cell separation device according to one embodiment of the present invention.

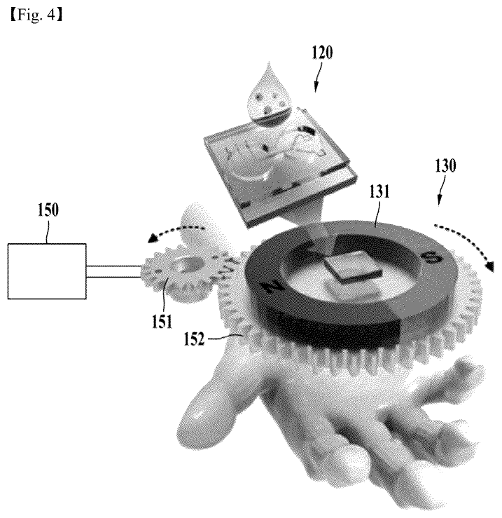

FIG. 4 is another schematic diagram illustrating a simplified magnetic field generation unit of a magnetic-based portable multi-cell separation device according to one embodiment of the present invention.

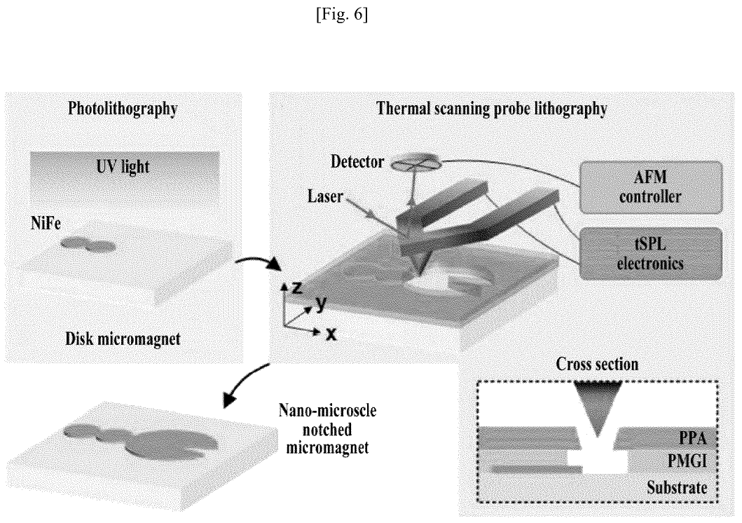

FIG. 6 is a schematic diagram illustrating an engineering approach of UV optical and thermal scanning probe lithography for micro-magnets and nano-scale notches in a magnetic-based portable multi-cell separation device according to one embodiment of the present invention.

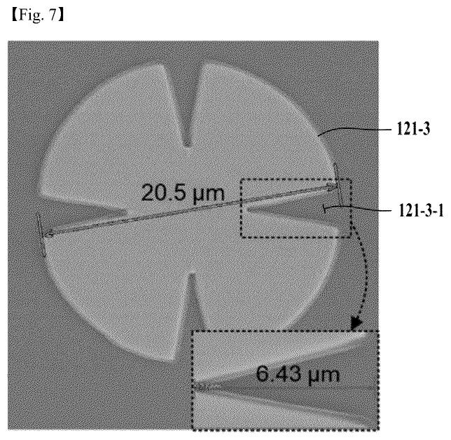

FIG. 7 is a schematic diagram illustrating an SEM image of notched micro-magnets in a magnetic-based portable multi-cell separation device according to one embodiment of the present invention.

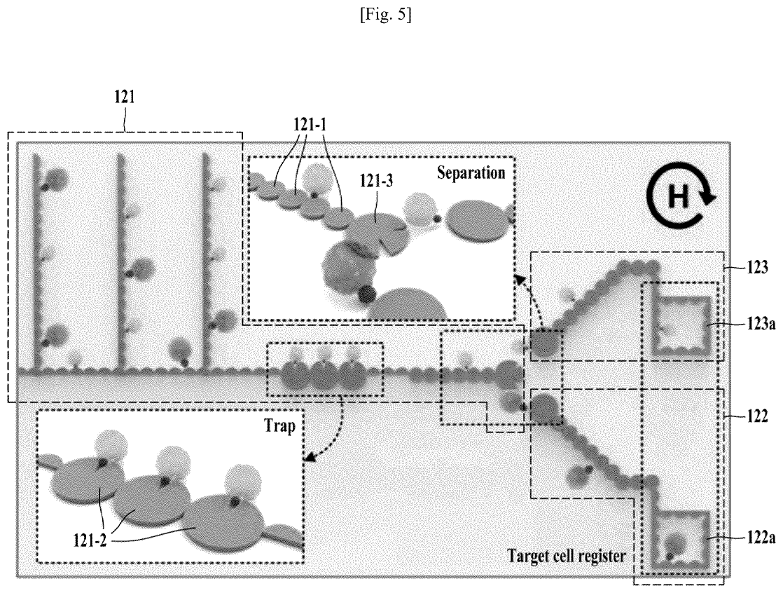

Referring to FIGS. 2 to 7, the overall structure of a magnetic-based portable multi-cell separation device (100) according to one embodiment of the present invention will now be described. The device comprises a microscope (110), a chip unit (120), a magnetic field generation unit (130), and a control unit (140).

The microscope (110) is configured to perform observations at the nanometer scale. The microscope (110) may be a nano-spectroscopy microscope.

The chip unit (120) is disposed below the microscope (110) and is configured to enable selective cell sorting and collection. The chip unit (120) comprises a first chip unit (121), a second chip unit (122), and a third chip unit (123).

The first chip unit (121) is provided to move and sort a plurality of cells, including target cells and non-target cells. The cells may be transported while being bound to carriers. The target cells refer to the cells designated for separation.

The first chip unit (121) comprises a plurality of circular magnets (121-1), a capture magnet (121-2), and a sorting magnet (121-3).

The circular magnets (121-1), the capture magnet (121-2), and the sorting magnet (121-3) may be made of a material comprising nickel-iron (NiFe), but are not limited thereto.

The plurality of circular magnets (121-1) have magnetism and are continuously arranged to transport cells or carriers bound to cells. The circular magnets (121-1) may be arranged in series, in parallel, or in a combination of series and parallel.

The capture magnet (121-2) is disposed adjacent to the circular magnets or arranged in series between them and is configured to capture non-target cells or carriers bound to non-target cells.

Notches are formed on the capture magnet (121-2) to trap carriers that transport non-target cells.

The sorting magnet (121-3) is disposed at one end of the plurality of circular magnets (121-1) and is configured to sort target cells and non-target cells.

The sorting magnet (121-3) has a plurality of notches (121-3-1) formed thereon, allowing carriers to jump from one side of the notch to the other.

The plurality of notches (121-3-1) are spaced apart at equal intervals with respect to the center of the sorting magnet (121-3).

The sorting magnet (121-3) of the first chip unit (121) is spaced apart from one end of both the second chip unit (122) and the third chip unit (123).

It is preferable that circular magnets having a diameter equal to or smaller than that of the sorting magnet (121-3) of the first chip unit (121) and larger than the other circular magnets (121-1) are provided at one end of the second chip unit (122) and the third chip unit (123).

The second chip unit (122) is spaced apart from the first chip unit (121) and is provided to sort target cells separated from the first chip unit (121).

A first chamber (122a) for storing target cells is provided at the other end of the second chip unit (122).

The third chip unit (123) is spaced apart from the first chip unit (121) and is provided to sort non-target cells separated from the first chip unit (121).

The third chip unit (123) includes a second chamber (123a) at its distal end, which serves as a target cell register for storing non-target cells.

It is preferable that the second chip unit (122) and the third chip unit (123) are continuously configured with a plurality of circular magnets.

The magnetic field generation unit (130) is disposed inside a magnetic member (131), which has magnetism, and is configured to adjust the magnetic field.

The magnetic member (131) preferably has an annular shape, with the chip unit (120) positioned at a sample region located at the center.

The control unit (140) controls the operation of both the microscope (110) and the driving unit (150).

The control unit (140) comprises a microcontroller configured to perform computational processing of data.

Additionally, the control unit (140) may include a memory for storing data processed by the microcontroller.

According to the present invention, the magnetic field generation unit (130) may further include a driving unit (150) configured to enable horizontal rotation.

The driving unit (150) is preferably controlled by the control unit (140).

For example, the driving unit (150) may be a motor and may include a gear member (151) for transmitting power.

The gear member (151) has a toothed structure formed on its outer peripheral surface.

The gear member (151) is interposed between the driving unit (150) and the base plate (152) to transmit power.

The upper surface of the base plate (152) is provided with the chip unit (120) and the magnetic field generation unit (130), which is positioned in the sample region of the internal space.

The base plate (152) enables the magnetic field generation unit (130) to rotate horizontally. In some cases, the base plate (152) may allow the chip unit (120) to rotate.

The outer peripheral surface of the base plate (152) is formed with a toothed structure, allowing power transmission, enabling horizontal rotation, and facilitating adjustment of the magnetic field generated by the magnetic field generation unit (130).

The base plate (152) is coupled to a supporting structure at the bottom, allowing horizontal rotation.

The manufacturing method for the array structure composed of the circular magnets (121-1), capture magnet (121-2), and sorting magnet (121-3) of the chip unit (120) consists of two steps.

First, circular micro-magnets are fabricated through photolithography and sputtering processes. Then, the positions of the notched magnets are patterned using thermal scanning probe lithography, followed by an additional sputtering process to complete the fabrication.

The overall research and development process leading to this invention can be explained as follows: Micro-magnetic patterns control the movement of microscale biological carriers by leveraging localized magnetic energy. By arranging these patterns in a regular array, it becomes possible to simultaneously manipulate large-scale cells with only external stimulation. The final magnetic field is controlled wirelessly.

TABLE 1

| | Magnetic | Multi- | | Simultaneous | |
|---|---|---|---|---|---|
| | field/ | direc- | | manipulation | Field |
| Magnetic | Electric | tional | Gating | of bead | genera- |
| element | field | transport | function | and cell | tion |
| [symbol] array | [symbol] k [symbol] /0.8 | No | No | Multiple | EM |
| | MV [symbol] | | | | |
| Micro [symbol] | [symbol] 0 O [symbol] | Yes | No | Few | EM |
| Magnetic | [symbol] 00 O [symbol] - | Yes | Yes | Multiple | EM |
| conduits | 500 O [symbol] | | | | |
| Magnetic | <500 O [symbol] | Yes | No | Multiple | EM |
| rings | | | | | |
| [symbol] track | <400 O [symbol] | Yes | No | Few | EM |
| Tri- [symbol] track | <200 O [symbol] | No | Yes | Multiple | EM |
| Curved track | < [symbol] 00 O [symbol] | Yes | Yes | Multiple | EM |
| | 400 O [symbol] | Yes | No | Multiple | EM |
| Parallel | <45 O [symbol] | No | Yes | Multiple | EM |
| stripes | | | | | |
| Micro [symbol] | <100 O [symbol] | Yes | Yes | Multiple | EM |
| Notched | <50 O [symbol] | Yes | Yes | Multiple | PM |
| microdisk | | | | (≈2500 [symbol] ) | |

[symbol]

Simultaneous manipulation of beads and cells per mm [symbol] (Multiple: >1000 cells mm [symbol] ). [symbol]
indicates data missing or illegible when filed

Comparison of Various Magnetophoresis Approaches for Carrier and Cell Manipulation (EM: Electromagnet, PM: Permanent Magnet)

Table 1 compares different magnetophoresis approaches in terms of the applied magnetic field, multidirectional transport, gating functionality, simultaneous manipulation, and magnetic field generation method. These approaches enable efficient manipulation and sorting at the single-cell level based on various magnetic elements.

In particular, in disk-shaped micro-magnets, bio-carriers and cells rotate individually along the boundary and synchronize with the externally applied rotating magnetic field. By designing the desired microdisk configuration array, various manipulation and autonomous gating functionalities can be demonstrated in a programmable manner with high throughput.

Microdisks exhibit a multi-magnetic domain structure that is randomly positioned under magnetic fields lower than the saturation field. This multi-domain structure induces discontinuous changes in magnetization, leading to localized discontinuous movements of the magnetic energy well, which can interfere with precise control of the driving force.

Previous studies have mainly used electromagnetic mechanisms to generate high-intensity in-plane rotating magnetic fields, enabling micro-magnets to operate in a single-domain state. Additionally, achieving stable control and selective cell sorting requires current control and 3D magnetic fields. However, generating a magnetic field using large-scale electromagnetic systems that require additional equipment and external connections remains a major barrier to the development of portable cell-on-chip platforms for multi-cell screening.

To overcome these challenges, it is essential to develop techniques for effectively manipulating magnetic bio-carriers under low magnetic field conditions using simplified devices.

In the present invention, a sophisticated engineering approach for selective cell sorting in a handheld chip with minimal rotating magnetic fields is introduced. This approach involves the use of customized nano-microscale notches in disk-shaped permalloy micro-magnets to selectively sort magnetic carriers.

The magnetic carriers move simultaneously along an array of disk-shaped micro-magnets and are guided toward notched micro-magnets, where separation occurs. In this system, two-step lithography was used to effectively fabricate multiple sorting gates.

First, disk-shaped micro-magnets were patterned using photolithography.

Second, nano-microscale notched micro-magnets were aligned with the previously fabricated disk micro-magnets and patterned at the desired locations on the chip using thermal scanning probe lithography.

The notches in the micro-magnets induce irregular changes in the multi-magnetic domain configuration. These localized variations subsequently regulate discontinuous changes in the magnetic potential energy landscape near the notches, inducing jumping motion of magnetic carriers and enabling the gating function of carriers bound to specific cells.

Inspired by the discontinuous magnetization transitions observed in the classical magnetic Barkhausen effect, the concept of the Barkhausen effect due to mesoscopic-scale magnetic discontinuities (MMB effect) was proposed to describe this phenomenon, which involves irregular magnetization accompanied by discontinuous wall motion.

To verify the feasibility of this approach, it was demonstrated that magnetic carriers can be controlled under low magnetic fields using a simplified magnetic field generator. The control field generator was constructed using a motor-driven rotating Halbach-structured permanent magnet to achieve a uniform in-plane magnetic field within the sample region.

Additionally, as shown in FIGS. 3 and 4, the performance of the fabricated separation circuit was evaluated, demonstrating effective separation of various cells.

For device design, numerical simulations were conducted to analyze the movement of magnetic beads in disk micro-magnets with or without notches of varying sizes. The magnetic energy of the micro-magnets was calculated, and the dynamic motion of the magnetic beads was analyzed to optimize the separation parameters.

As a result, the device successfully separated and collected various magnetic carriers efficiently under a low magnetic field (≤50 Oe) and low frequency (≤0.3 Hz).

Here, Oe (oersted) refers to the unit of magnetic field strength.

Additionally, the nano-scale notched disk micro-magnet device successfully labeled, separated, and sorted THP-1 and MCF-7 cells using magnetic carriers. The successful integration of this technology into a portable device demonstrates its potential applications in POCT cell chip applications.

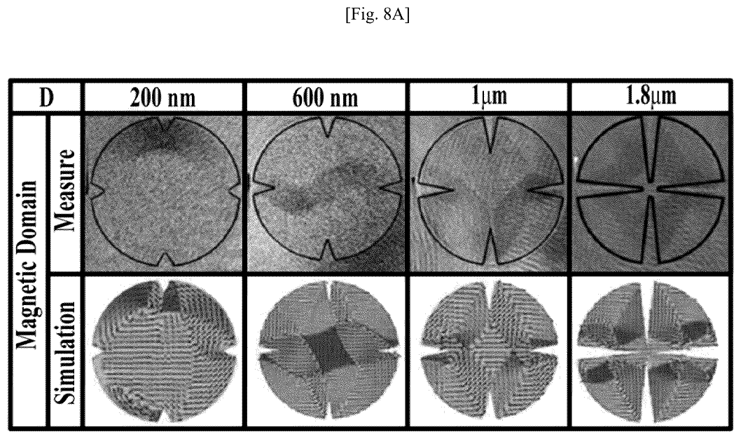

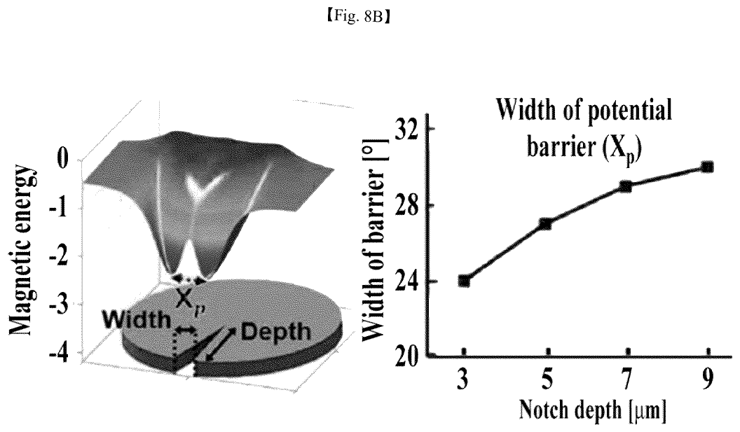

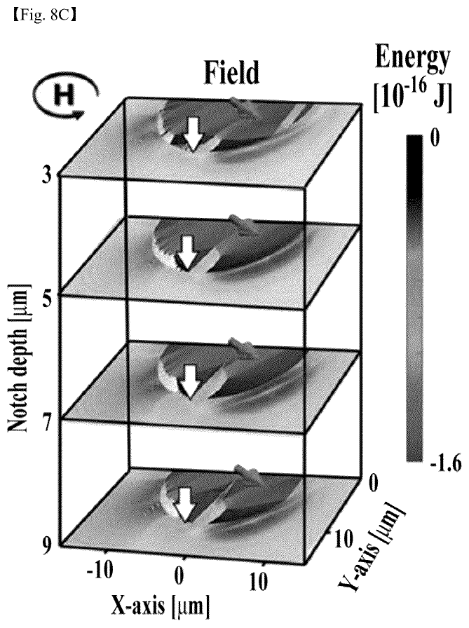

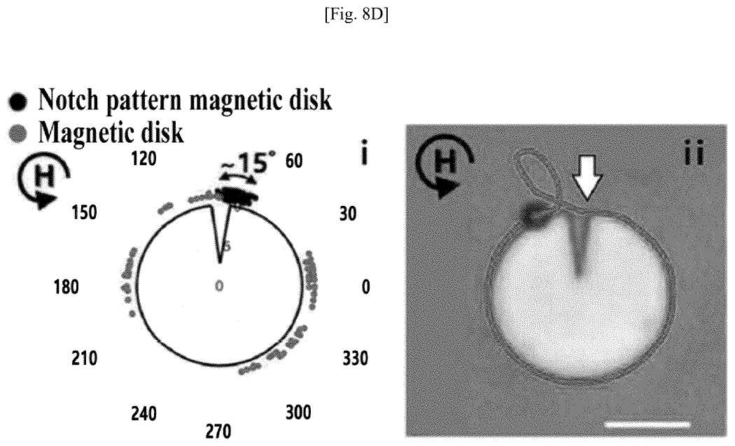

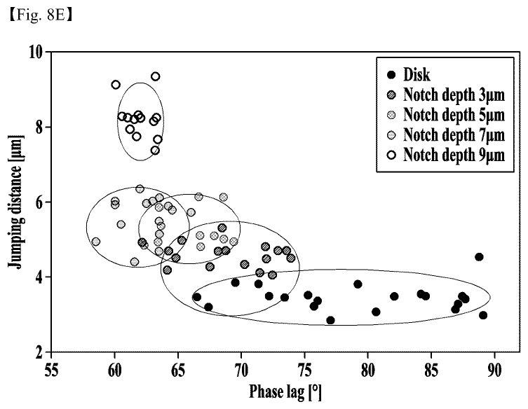

FIGS. 8A to 8E are diagrams illustrating the relationship between the magnetic domain of notched disk micro-magnets and the dynamics of magnetic carriers.

FIG. 8A shows the observed magnetic domain and corresponding simulation results when an in-plane magnetic field of 50 Oe is applied to quadruple-notched disk micro-magnets with different depths (D).

FIG. 8B illustrates the change in energy barrier width (Xp) according to notch depth in a disk micro-magnet magnetized in the notch direction.

FIG. 8C compares magnetic domain simulations and energy landscapes (indicated by purple arrows) as a function of notch depth, when the in-plane magnetic field angle changes from 135° to 0° at 40 Oe.

FIG. 8D compares the jumping carrier positions between a disk micro-magnet (blue) and a notched disk micro-magnet (red) over 20 magnetic field rotation cycles. The jumping position corresponds to the angle at which the carrier completely detaches from the micro-magnet (indicated by white arrows in ii). The distribution of red dots indicates narrow confinement near the notches.

FIG. 8E presents the phase delay of magnetic carriers and the changes in jump distance over 20 repetitions of external magnetic field rotation, with different colors representing variations according to notch depth.

Referring to FIGS. 8A to 8E, the induced MMB effect through nano-scale notch tuning can be explained as follows.

To describe the dynamics of the cell carriers, the previously established concept of magnetic carrier phase classification was utilized. The term “phase lag” was defined as the angular difference between the external magnetic field direction and the carrier position at the center of the disk micro-magnet.

Carriers trapped in the energy well moved slower than the magnetic field direction due to liquid resistance. As the driven rotational frequency increased under a rotating magnetic field, the phase lag gradually increased. When the driven frequency exceeded a certain “critical frequency”, the carrier experienced a radial repulsive force and jumped away from the micro-magnet with an increased phase lag, a phenomenon referred to as the “phase slipping mode”.

The phase lag at which the transition from the attractive region to the repulsive region occurred was defined as the “repulsive angle”. Consequently, the carrier jumped at the repulsive angle, leading to separation.

As the frequency exceeded a threshold critical value, the rotational motion frequency of the carrier around the micro-magnet became zero, leading to a phenomenon termed the “phase isolation mode”.

The nano-scale V-shaped notches were designed to have specific depths in the disk micro-magnet, enabling the precise control of the repulsive angle and inducing the MMB effect at low magnetic fields.

To analyze the carrier dynamics and operating conditions, numerical simulations were conducted, and the observed magnetic domains were compared with simulated results, verifying the magnetic states of the nano-microscale notched disk micro-magnets. These domain changes were used to calculate the magnetic energy wells where the carriers were positioned.

To confirm the reliability of the simulation results, disk micro-magnets with four nano-scale notches positioned at 0°, 90°, 180°, and 270° along the x-axis from the center of the micro-magnet were designed. The micro-magnets were composed of Ni₈₀Fe₂₀ with a radius of 2 μm and a thickness of 100 nm. The notch width was fixed at 200 nm, while the notch depths were set to 0.2, 0.6, 1, and 1.8 μm.

The magnetic domain patterns in 4 μm structures were measured under a magnetic field strength of 50 Oe using magnetic transmission X-ray microscopy (MTXM). The resulting domain configurations closely matched the simulation results under the same conditions, as shown in FIG. 8A. All simulation parameters were identical to those used in the experimental setup.

The magnetic energy distribution was calculated for different notches under a single-domain state.

When the notch direction was at 90°, the magnetic energy formed a localized energy barrier centered around 90°, creating two energy wells. The width of the energy barrier (Xp) increased with notch depth.

FIG. 8C shows the simulated magnetic energy distribution calculated from the magnetic domain simulation when a 135° magnetic field was applied. In the calculated magnetic energy, the depth of the energy wells (indicated by white arrows) was observed to increase with notch depth.

Generally, it is assumed that carriers are positioned in localized energy wells. However, if the barrier is sufficiently small relative to the carrier size, the carrier can jump over the barrier.

Thus, when the carrier approached the notch of the magnetic well indicated by the white arrows, smaller carriers were unable to overcome the barrier.

The well transitioned radially as it reached the repulsive angle, allowing the carrier to pass through the notch, thereby inducing the MMB effect.

However, for larger carriers, it is expected that they cross the well and settle in the lower energy well on the opposite side.

The movement of a 2.8 μm diameter carrier along a 20 μm diameter notch-free disk was tracked for 20 cycles at a rotation frequency of 0.25 Hz under a magnetic field of Oe.

Phase slipping can cause carrier jumps at arbitrary positions in a notch-free disk micro-magnet, as indicated by the blue dots in FIG. 8D.

However, from the magnetic energy simulation results, it is evident that the energy barrier of the notch influences the repulsive angle, thereby restricting carrier jumps to occur at the notch rather than at arbitrary positions.

The carrier jump locations are observed at the notch, as represented by the red dots.

Here, the blue dots appear randomly over a wide angular range, whereas the red dot distribution is narrowly confined near the notch due to the MMB effect, with an angular range of 15°.

To observe the changes in carrier jump angle and height, repeated experiments were conducted using various notch depths.

The jump angle is defined as the phase lag at which the jump begins, and the jump height is defined as the shortest distance between the micro-magnet and the carrier.

As shown in FIG. 8E, the range of jump angles decreased, while the jump distance increased as the notch depth increased. This is because a greater notch depth results in a stronger magnetic field gradient at the notch edge, which is essential for the MMB effect.

For the notch-free disk micro-magnet, the jump distance and angle (indicated in blue in FIG. 8E) were approximately 2 to 3 times smaller and 5 to 6 times wider, respectively, compared to those of a 9 μm single-notched micro-magnet (indicated in red).

These results suggest that by tuning nano-scale notches, the jump position and distance can be effectively controlled even under low magnetic field conditions where multiple magnetic domains exist.

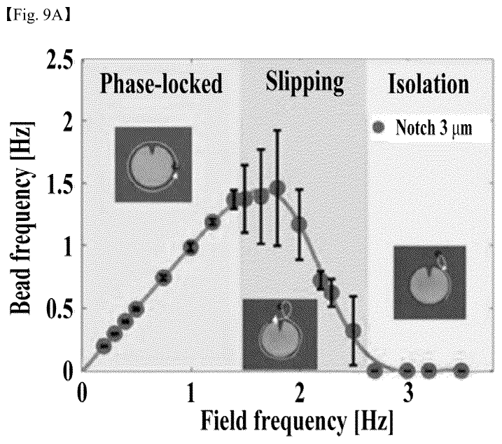

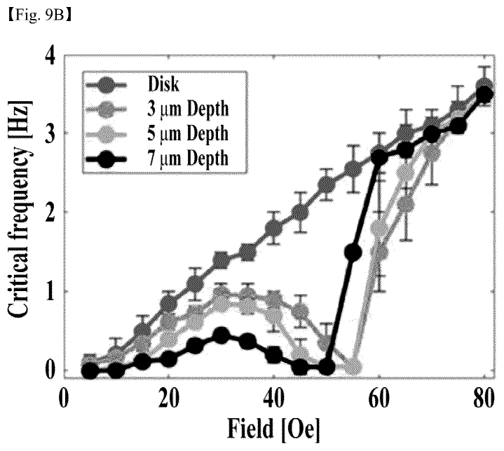

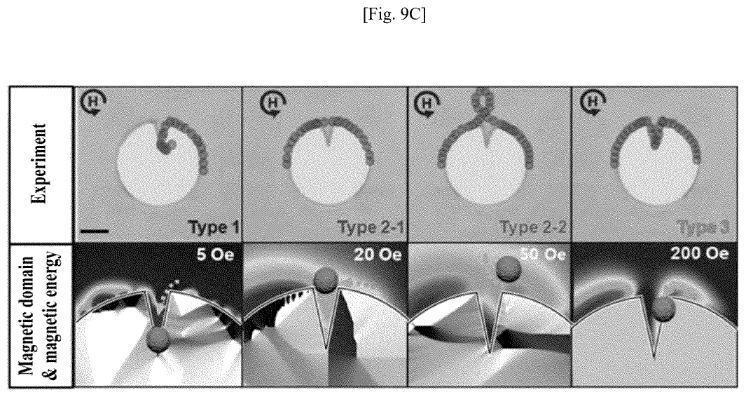

FIGS. 9A to 9C illustrate the regulation of magnetic carrier motion facilitated by notched disk micro-magnets.

FIG. 9A shows the frequency variation of a micro-magnet with a notch width of 3 μm and a depth of 3 μm as the magnetic field frequency increases, using a 2.0 μm magnetic carrier. The magnetic field strength is 40 Oe, and the micro-magnet has a diameter of 20 μm.

FIG. 9B illustrates the variation in the critical frequency of the magnetic carrier as a function of notch depth under the same conditions. It shows that for notched disks, abnormal phase separation is observed between 30 and 60 Oe.

FIG. 9C compares the measured displacement of magnetic carriers smaller than the notch width at different magnetic field strengths, along with the magnetic domain shape and magnetic energy distribution around the notch. The scale bar represents 5 μm, while the notch width is 3 μm and the depth is 5 μm.

Referring to FIGS. 9A to 9C, the regulation of carrier motion in notched micro-magnets can be explained as follows.

To precisely adjust the notch, the carrier dynamics must be analyzed using notch parameters.

In the previous section, it was assumed that the carrier was positioned at the minimum energy point of the well. However, a moving carrier is influenced not only by magnetic forces but also by fluid viscosity.

The viscous force was proportional to the relative velocity between the carrier and the fluid.

Therefore, as the frequency of the rotating magnetic field increased, the viscous force increased, causing the carrier to be displaced from the minimum energy point until it reached a position where the magnetic force and viscous force were balanced.

The critical frequency of the carrier is determined by the viscosity of the fluid and the magnetic field strength.

Additionally, since the size of the energy barrier varies with notch depth, the notch depth can influence the critical frequency.

To investigate the variation in critical frequency of a 2.0 μm diameter carrier depending on notch depth (3, 5, and 7 μm), the carrier motion was observed while varying the magnetic field strength and frequency.

FIG. 9A presents the critical frequency, where the X-axis represents the field frequency and the Y-axis represents the bead frequency, for a notch width and depth of 3 μm and 3 μm, respectively.

When the driving frequency exceeded the critical frequency, intermittent jumps occurred, transitioning the carrier motion into the phase slipping mode. Additionally, as the magnetic field frequency increased, the carrier frequency reached 0 Hz, transitioning into the phase isolation mode.

For the notch-free disk micro-magnet, the critical frequency increased proportionally with the magnetic field strength. However, in the notched disk micro-magnet, the critical frequency decreased at 30 Oe, reaching 0 Hz between 50 and 60 Oe, exhibiting abnormal phase slipping, as shown in FIG. 9B.

As the notch depth increased, the critical frequency decreased, promoting a faster transition into the abnormal phase slipping mode and subsequently faster recovery.

Above 70 Oe, the critical frequency increased sharply, becoming similar to that of a notch-free disk micro-magnet.

The motion of a 2.8 μm carrier can be classified into three types:
Type 1: The carrier enters the notch along the boundary of the micro-magnet and becomes trapped, exhibiting a phase-locked mode.
Type 2: The carrier jumps near the notch.
Type 3: The carrier enters the notch and then escapes.

The jump height was greater than or equal to zero depending on the magnetic field strength.

When the jump height was zero, it was classified as Type 2-1.

When the jump height was greater than zero, it was classified as Type 2-2, exhibiting abnormal phase slipping mode.

At a magnetic field strength of 10 Oe, when the notch width was in the range of 3 to 3.5 μm, the carrier moved according to Type 1.

When the notch width reached 5 μm, it corresponded to Type 2-1, and at 7 μm, it exhibited the characteristic behavior of Type 2-2.

The simulation results of FIG. 9C show that under weak magnetic fields, multiple small magnetic domains (white and black) were nucleated near the notch. This led to the formation of irregular magnetic energy wells of varying sizes.

During magnetic field rotation, the nearest energy well to the carrier shifted inside the notch, causing the carrier to become trapped within the notch (Type 1).

As the magnetic field strength increased, the segmented magnetic domains merged, and the energy well across the notch transformed into a broader shape on the opposite side, representing Type 2. In this case, the carrier was able to jump from one side of the notch to the other.

With a further increase in the magnetic field, two energy wells formed near the notch, altering the jump direction and height. As a result, two types of jumps were observed: Type 2-1 and Type 2-2.

As the magnetic field strength continued to increase, the magnetic domains merged, forming a narrow energy well along the notch boundary. Consequently, the carrier was able to pass around the notch edge, exhibiting Type 3 behavior.

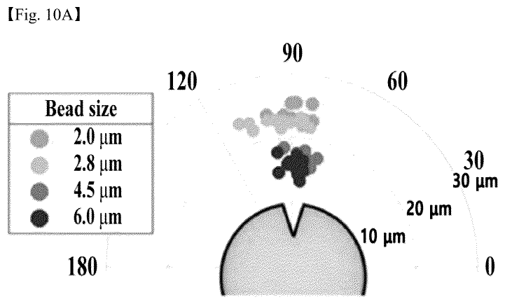

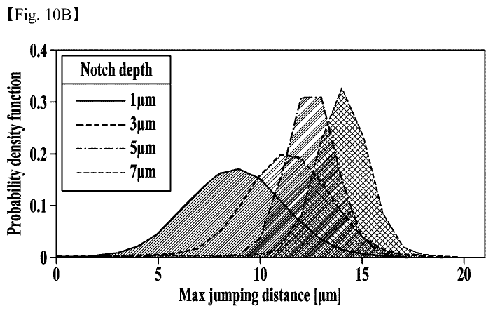

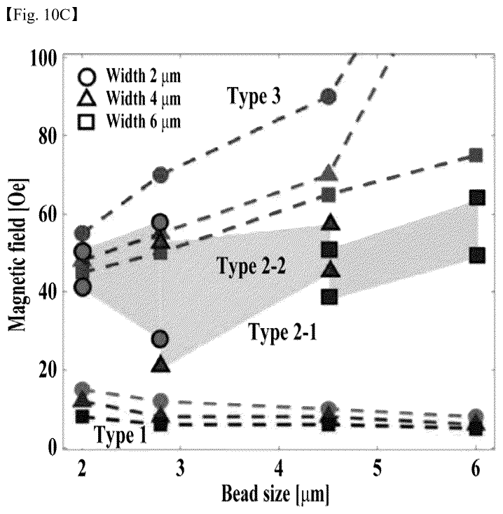

FIGS. 10A to 10C illustrate the separation conditions for magnetic carriers of different sizes in notched disk micro-magnets.

FIG. 10A shows the jump distribution of magnetic carriers of various sizes in a notched disk micro-magnet with a depth of 5 μm under Type 2-2 conditions.

FIG. 10B presents the jump probability distribution of a 2.8 μm magnetic carrier as a function of notch depth under Type 2-2 conditions.

FIG. 10C is a phase diagram representing the motion of magnetic carriers influenced by notch width (3 μm, 5 μm, and 7 μm) and magnetic field strength. In the diagram, carrier jumps for Type 2-2 are defined within operating parameters where the speed is ≤0.2 Hz and the jump distance exceeds 7.5 μm (colored regions).

Regarding the classification gate efficiency under various operational parameters, the classification behavior of the tailor-notched micro-magnet indicates that micro-magnets can still perform separation functions even under low magnetic field strength and frequency conditions, which are optimized to activate jumps for carriers of a specific size.

By analyzing the carrier jump behavior under Type 2-2 conditions, the classification gate was optimized.

FIG. 10A displays the distribution of jump distances and angles for various carrier sizes over 15 cycles. The critical frequency was ≤0.2 Hz, and jumps occurred around the notch regardless of carrier size. Smaller carriers exhibited higher jumps, and jump distances increased as notch depth increased.

Overall, as shown in FIG. 10B, the jump distance probability distribution was measured for various notch depths.

For parameter optimization, the phase diagram of magnetic carrier movement types was classified based on magnetic field strength and carrier size, as shown in FIG. 10C. The green region represents the operating area where the micro-magnet can function as a separation element under Type 2-2 mode.

Three different carrier size ranges demonstrate the expression of Type 2-2 mode under specific notch conditions.

Thus, the optimal operating range of the magnetic field and notch parameters was selected to achieve high gating efficiency at low magnetic fields, making the system suitable for handheld applications.

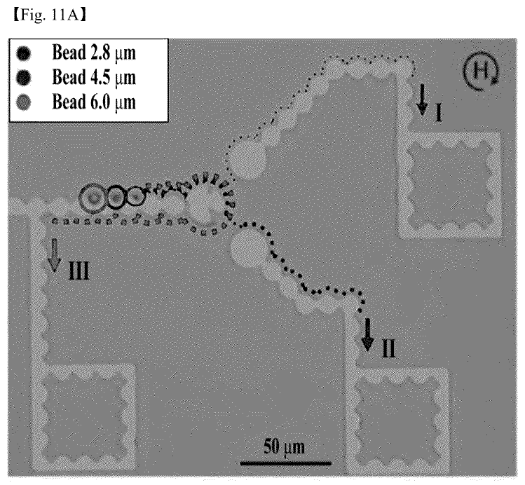

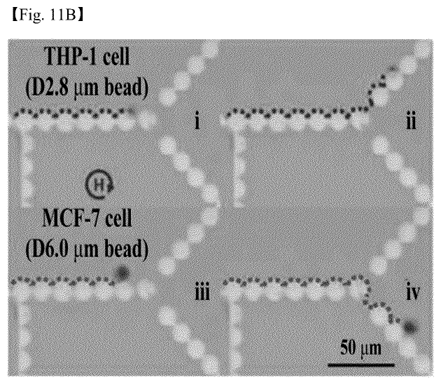

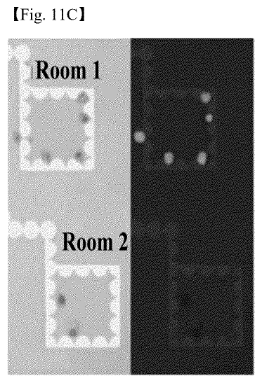

FIGS. 11A to 11C illustrate the autonomous separation of carriers and the simultaneous separation of THP-1 and MCF-7 cells using a POCT system with a Halbach magnet assembly.

FIG. 11A shows the separation of three different sizes of magnetic carriers (2.8, 4.5, and 6.0 μm) into individual compartments using two types of notched disk micro-magnet devices. The upper notch has a depth of 5 μm and a width of 3 μm, while the lower notch has a depth of 7 μm and a width of 6 μm.

FIG. 11B illustrates the simultaneous separation of THP-1 and MCF-7 cells. The separation of live THP-1 and MCF-7 cells was tested in a cell culture environment (10% FBS RPMI medium) using a multi-notched disk micro-magnet device. The trajectories of live THP-1 and MCF-7 cells were observed in the multi-notched disk micro-magnet device (i-iv), showing that they were separated into individual compartments under a rotating magnetic field of 40 Oe at 0.2 Hz.

FIG. 11C presents bright-field and fluorescence images of captured THP-1 cells stained with a green fluorescent dye and labeled MCF-7 cells in separate compartments.

### Simultaneous Separation of Various Types of Live Cells in the POCT Platform

For simultaneous separation of various types of live cells under the analyzed classification conditions, the POCT system was designed using a weak magnetic field generation system with a Halbach structure.

The Halbach structure was assembled with sintered neodymium (NdFeB) permanent magnets, which were arranged in a mold printed using an FDM (Fused Deposition Modeling) 3D printer.

The Halbach structure was designed through magnetic field simulations using Ansys Maxwell software, achieving a uniform magnetic field ranging from 15 to 60 Oe.

Using FEMM 3.0 software, the magnetic field distribution of the Halbach array magnets was analyzed, confirming that it provided high uniformity within the sample region.

Additionally, the main body of the system was fabricated using an FDM 3D printer, and the rotation mechanism was controlled by Arduino, which managed the speed and direction of the motor.

The measurement results confirmed that magnetic carriers were successfully separated based on their size.

This demonstrates that carriers or cells can be separated using a simple permanent magnet system, replacing the rotating magnetic field of a 2D electromagnet system.

At an optimized magnetic field strength of Oe and a frequency of 0.2 Hz, a multi-notched disk micro-magnet was developed as a separation gate element to separate magnetic carriers with diameters of 2.8 μm and 4.5 μm, and its classification performance was demonstrated, as shown in FIGS. 11A to 11C.

The jumping gate element was designed with notches of 5 μm depth and 1.5 μm width and 9 μm depth and 3.5 μm width. Three sets of carriers with diameters of 2.8 μm, 4.5 μm, and 6.0 μm were loaded into the fabricated device, which consisted of a notch-free micro-magnet array and gate elements.

First, the 2.8 μm diameter carriers were separated into Path I.

Second, the 4.5 μm diameter carriers were classified into Path II through jumping.

Finally, the largest remaining carriers moved into Path III without jumping.

Additionally, cells were labeled with magnetic carriers, and autonomous separation based on cell type was demonstrated.

THP-1 and MCF-7 cells were labeled with magnetic carriers of 2.8 μm and 6.0 μm diameters, respectively.

As shown in FIGS. 11A to 11C, under optimized operating conditions of a 40 Oe field strength and a 0.2 Hz frequency, the multi-notched disk micro-magnet successfully separated two types of cells in different directions. The isolated cells were identified using bright-field and fluorescence imaging (FIG. 11B).

In the experiment, a labeled method was used, in which superparamagnetic carriers were bound to the cells for cell control, but a label-free method may also be utilized.

The multi-notched disk micro-magnet developed in this invention enables versatile manipulation of magnetic carriers and cells, even under low magnetic field conditions, making it suitable for point-of-care testing (POCT) systems.

In conventional magnetophoretic circuits, if the applied magnetic field is weaker than the saturation field, the micro-magnet exhibits multiple domains, making it difficult to achieve precise manipulation of magnetic carriers.

However, the multi-notched disk micro-magnet overcomes these challenges by enabling various carrier operations, such as separation, trapping, and delay, even under weaker and slower rotating magnetic fields.

By integrating this device with a Halbach-structured permanent magnet assembly, a greater number of carriers can be controlled within a smaller area, expanding its applicability to various systems.

This technology enables the precise separation and control of individual cells, even with small magnetic field generators using permanent magnets, marking a significant milestone for the further development and implementation of next-generation POCT and Cells-on-Chip technologies.

Overall, this technology has the potential to revolutionize rapid cell analysis by providing a simple, cost-effective, and efficient solution for the analysis of biologically active materials and cells.

To further explain the experiments conducted in accordance with the present invention, the external magnetic field was generated using four ferrite-core solenoid coils, which produced a rotating in-plane magnetic field in the x-y plane.

The strength and frequency of the rotating magnetic field were controlled using LabVIEW (Laboratory Virtual Instrument Engineering Workbench) software.

A Halbach array magnetic field generator, composed of neodymium iron boron (NdFeB) permanent magnets and a holder fabricated using an FDM 3D printer, was used to apply a magnetic field to the POCT magnetophoresis system.

A stick-shaped NdFeB magnet with dimensions of 5×5 mm (diameter and thickness) was used as a neodymium (Nd) permanent magnet in the hybrid (HB) magnet system.

The uniformity of the magnetic field generated by the Halbach array structure was verified using ANSYS Maxwell software.

The rotational magnetic field generator was fabricated using a 3D printer and consisted of a gear holder enabling mechanical rotation, a rotating motor, and an Arduino chip to control the motor's rotation.

### Fabrication of Nano-Scale Notched Micro-Magnets and Array Preparation

A two-step lithography technique was used to fabricate the micro-magnets.

Photolithography was primarily employed to pattern microstructures for the fabrication of most micro-magnets.

Additionally, to create nano-scale notches on micro-magnets and micro-magnet arrays, a one-step thermal scanning probe lithography (t-SPL) technique was developed.

The fabrication of micro-magnets other than notched disk micro-magnets was also reported.

Using photolithography and direct-current magnetron sputtering, an array of micro-magnets was produced by depositing Ni₈₀Fe₂₀ thin films (thickness: 100 nm) onto an Si substrate.

For the fabrication process of the notched disk micro-magnet case, a pure PMGI-SF4 (polymethylglutarimide, Sigma) solution was spin-coated onto the sample surface at 2000 rpm with an acceleration of 500 rpm/s for 45 seconds, followed by rapid baking at 200° C. for 1 minute.

Next, a PPA (polyphthalaldehyde, Sigma) solution (1.3 wt % in anisole) was spin-coated onto the PMGI layer at 3000 rpm with an acceleration of 500 rpm/s for 60 seconds, followed by rapid baking at 90° C. for 3 minutes.

Under these conditions, a 30 nm-thick PPA film was deposited on top of a 155 nm-thick PMGI film on the sample surface.

PPA patterning was achieved using a commercial t-SPL system (NanoFrazor, SwissLitho AG) equipped with a tip of 20-100 nm radius.

For high heat transfer efficiency and high-resolution linewidths exceeding 100 nm, the selected tip was heated to approximately 950° C. for patterning.

The writing process involved heating the tip above 150° C. on the 2D/PPA surface, then bringing the tip into contact with the sample at a height of approximately 300 nm between the sample and cantilever.

The pattern image, drawn in a CAD program, was processed using NanoFrazor software, which divided it into a 20×20 nm mesh.

After patterning, the sample was immersed in a deionized water solution of tetramethylammonium hydroxide (TMAH, AZ726 MIF, MicroChemicals, 0.17 mol L⁻¹) for 155 seconds. It was then rinsed with deionized water (30 seconds) and isopropyl alcohol (30 seconds), followed by drying with N₂.

Metal deposition was performed using DC magnetron sputtering, along with other micro-magnet fabrication methods.

The lift-off process involved immersing the sample in Remover PG (MicroChem) for several hours, followed by rinsing with methanol and drying with N₂.

Subsequently, a 500 nm Teflon film was coated to reduce surface adhesion between the carrier and the cell.

The notched disk micro-magnets were fabricated with a minimum linewidth resolution of 90 nm.

For array micro-magnets, excluding the notched disk micro-magnets, fabrication was performed based on photolithography.

Afterward, the notched disk micro-magnets were aligned at the correct positions using NanoFrazor equipment.

For magnetic domain and magnetic field observation and simulation, the micro-magnet patterns were fabricated on X-ray transparent SiN membranes using electron beam lithography and a sequential lift-off process for magnetic domain observation.

A magnetic film (Ni₈₀Fe₂₀, 100 nm thickness) was deposited via DC magnetron sputtering.

The domain structure was observed using full-field magnetic transmission X-ray microscopy (MTXM) at an advanced light source (XM-1, beamline 6.1.2) with high spatial resolution of 25 nm.

The X-ray magnetic circular dichroism (XMCD) mechanism was utilized to enhance magnetic contrast.

The photon energy was set to Fe L₃ (707 eV).

To enhance magnetic contrast and remove non-magnetic background, images captured at specific fields were normalized using reference images recorded in the saturation state.

To observe the full domain structure of the micro-magnets, the 2D size of the notched disk micro-magnet (4 μm diameter) was scaled down due to the beam size limitations of MTXM.

In contrast, microscale magnetic domain and field simulation, as well as magnetic carrier manipulation, were performed using MuMax3 software.

The parameters were set as standard material properties:

Exchange stiffness Aex=1.0×10⁻¹¹ J/m⁻¹, Saturation magnetization Ms=800 kA/m⁻¹, Damping constant α=0.1, Magnetocrystalline anisotropy=0

The cell dimensions for the 4 μm diameter notched micro-magnet were 5×5×20 nm³, while the cell dimensions for the 20 μm diameter notched micro-magnet were 20×20×100 nm³.

The magnetic potential energy of a spherical superparamagnetic particle in a spatially and temporally varying magnetic field B with a linear volumetric susceptibility [symbol] is given by the following equation:

$$\text{?} \qquad ( 1 )$$

$$\text{?} \text{indicates text missing or illegible when filed}$$

Here, V represents the volume of the particle, and μ₀ is the vacuum permeability.

The total magnetic field B at the center of the particle is given by:

$$B = {B}_{ext} + {B}_{sub}$$

where:
Bₑₓₜ(t) is the uniformly rotating external magnetic field, and
B_{sub}(r,t) is the spatially and temporally varying substrate magnetic field.

The magnetic potential energy was numerically computed based on the simulated magnetic field using MATLAB R2021b.

### Cells Culture and Superparamagnetic Carrier Binding

For cell culture, THP-1 cells (ATCC, TIB-202) and MCF-7 cells (ATCC, HTB-22) were cultured in RPMI 1640 medium (Gibco, 11875-085) and DMEM medium (Gibco, 12430-054), respectively. Both media were supplemented with 10% FBS and 1% penicillin/streptomycin.

For superparamagnetic carrier binding, two types of antibodies, HLA-A2 and EpCAM, were used to label THP-1 and MCF-7 cells, respectively.

To obtain biotinylated antibodies, each antibody solution (0.5 g/L⁻¹) was mixed with a biotin-PEG-NHS linker solution (1 g/L⁻¹) using a vortex rotator for 1 hour.

The solution was then filtered using a spin desalting column to remove unbound linkers.

Streptavidin-coated magnetic carriers (diameter: 2.8 μm, M-280; Invitrogen, Grand Island, NY, USA) were conjugated with the biotinylated antibodies.

Next, the magnetic carriers were washed with PBS (pH 7.4).

Each biotinylated antibody was added to 5 μL of the carrier solution, ensuring a final antibody concentration of 3× 10 6 g/mL.

The solution was then thoroughly mixed using a vortex rotator at room temperature for 1 hour.

To remove unbound antibodies, a magnet was used to wash the carriers multiple times with PBS (0.02% Tween-20).

Finally, the antibody-conjugated carriers were suspended in 0.5 mL PBS and stored at 4° C. for future use.

Therefore, the magnetically driven portable multi-cell separation device according to the present invention can induce localized magnetic energy variations by modifying the structure of micro-magnets.

This approach eliminates the need for vertically applied magnetic field devices or current application devices, which were conventionally required for operating trapping and escape mechanisms.

Additionally, by controlling the jumping motion of magnetic particles under low magnetic field conditions (50 Oe) and low-frequency operation (≤1 Hz), the system enables precise manipulation of biomaterials using a simplified permanent magnet system, instead of a complex electromagnet system.

Additionally, by simplifying the system, high portability is achieved, making it applicable as an essential cell manipulation technology for next-generation biopharmaceutical technologies, such as point-of-care testing (POCT) kits.

As described above, although the embodiments have been explained with reference to limited diagrams, those skilled in the art will recognize that various modifications and variations can be made based on the above disclosure.

For example, the described techniques may be performed in a different order than presented, and/or the components of the described systems, structures, devices, and circuits may be combined or arranged in different ways than described. Additionally, they may be replaced or substituted with other components or equivalents while still achieving the intended results.

Therefore, other implementations, alternative embodiments, and equivalents to the scope of the following claims also fall within the scope of the present invention.

What is claimed is:

1. A magnetic-based portable multi-cell separation device, comprising:
a microscope configured to perform observation;
a chip unit disposed below the microscope and configured to enable selective cell sorting and collection;
a magnetic field generation unit configured to adjust a magnetic field, wherein the chip unit is disposed within an internal space of a magnetic member having magnetic; and
a control unit configured to control an operation of the microscope.

2. The magnetic-based portable multi-cell separation device of claim 1, wherein the chip unit comprises:
a first chip unit configured to move and sort a plurality of cells;
a second chip unit spaced apart from the first chip unit and configured to sort target cells separated from the first chip unit; and
a third chip unit configured to sort cells other than the target cells separated from the first chip unit.

3. The magnetic-based portable multi-cell separation device of claim 2, wherein the first chip unit comprises:
a plurality of circular magnets having magnetic and continuously arranged to perform transport;
a capture magnet disposed adjacent to the plurality of circular magnets and configured to perform capture; and
a sorting magnet disposed at one end of the plurality of circular magnets and configured to perform sorting.

4. The magnetic-based portable multi-cell separation device of claim 3, wherein the plurality of circular magnets are arranged in series, in parallel, or in a combination of series and parallel.

5. The magnetic-based portable multi-cell separation device of claim 3, wherein the sorting magnet has a plurality of notches formed in a circumferential direction toward the center.

6. The magnetic-based portable multi-cell separation device of claim 3, wherein the plurality of circular magnets, the capture magnet, and the sorting magnet are made of a material comprising nickel-iron (NiFe).

7. The magnetic-based portable multi-cell separation device of claim 3, wherein a first chamber for storing target cells is provided at an end of the second chip unit.

8. The magnetic-based portable multi-cell separation device of claim 3, wherein a second chamber for storing cells other than the target cells is provided at an end of the third chip unit.

9. The magnetic-based portable multi-cell separation device of claim 1, further comprising a base plate configured to enable the magnetic field generation unit to rotate horizontally.

10. The magnetic-based portable multi-cell separation device of claim 9, wherein an outer circumference of the base plate is formed with a toothed structure.

11. The magnetic-based portable multi-cell separation device of claim 1, further comprising a driving unit configured to enable the magnetic field generation unit to rotate horizontally.

12. The magnetic-based portable multi-cell separation device of claim 1, wherein the control unit comprises a microcontroller configured to perform computational processing of data.

13. The magnetic-based portable multi-cell separation device of claim 1,
wherein the cell sorting and collection are controlled by at least one of a labeled method or a label-free method.
